(19) United States
(12) Patent Application Publication
(10) Pub. No.: US 2004/0089733 A1
(43) Pub. Date: May 13, 2004

(54) Method and apparatus for purging a spray nozzle

(76) Inventor: Vilho Nissinen, Numminen (FI)

Correspondence Address: Michael C Stuart, Cohen Pontani Lieberman & Pavane, Suite 1210, 551 Fifth Avenue, New York, NY, 10176, US

(21) Appl. No.: 10/398,529

(22) PCT Filed: Oct. 12, 2001
(86) PCT No.: PCT/FI01/00889

(30) Foreign Application Priority Data
Oct. 12, 2000 (FI) 20002251

(51) Int. Cl. B05B 1/28; B05B 15/02

(52) U.S. Cl. 239/112; 239/104; 239/106; 239/119

(57) ABSTRACT

The present invention relates to a method for cleaning a clogged or contaminated spray nozzle (10) or the filter (14) of such a spray nozzle used in coating a web of paper or paperboard. Herein, into at least of portion of the coating mix flow channel (24) of the spray nozzle (10) to be cleaned is formed a cleaning medium flow running reverse to the normal flow direction of the coating mix. The invention also relates to an apparatus suited for implementing the method.

The present invention relates to a method according to the preamble of claim 1 for cleaning a clogged or contaminated spray nozzle or the filter of a spray nozzle. The invention also relates to an apparatus suited for implementing the method.

In the spray-coating technique of a moving web of paper or paperboard, the coating mix is applied to the surface of the web in the form of small droplets ejected from spray nozzles. Conventionally, high-pressure nozzles are used as the spray nozzles, whereby the coating mix is atomized into droplets when exiting from a small-diameter nozzle orifice under a high pressure. Typically, a plurality of nozzles are located in a row over the cross-machine width of the web being coated, and plural spray nozzle rows may be arrayed parallel to each other. The spray nozzles are enclosed in a hood that prevents the mist of coating mix not adhering to the surface of the web from escaping to the surrounding space. The spray-coating method is described, e.g., in U.S. Pat. No. 6,063,449.

In a spray-coating apparatus, flocked clumps of coating mix and other large-size particles can readily clog the small orifice of the high-pressure nozzle and the filter adapted to the rear portion of the spray nozzle. Clogging can be decreased through using nozzles of a larger orifice, wherein the coating mix spray is atomized with the help of injected air. This kind of air-assisted atomization, however, cannot generally atomize the coating mix into droplets of a sufficiently small size to achieve a good coating quality. The massive amount of air blown via the air-assisted nozzle causes mottling and other flow defects in the vicinity of the paper web surface. Furthermore, the atomizing air must be evacuated away from the application area of the coating mix, whereby the required suction arrangements particularly in wide coaters invoke turbulence and pulsing of air pressure in the enclosure surrounding the nozzle array, thus causing deterioration of the coating quality.

It is an object of the present invention to provide a novel type of method and apparatus for removal of clogging depositions from a clogged spray nozzle.

The goal of the invention is attained by imposing a flow of a cleaning liquid flow into the flow channel of the spray nozzle to be cleaned in a reverse direction to the normal flow of the coating mix, whereby the cleaning liquid flow removes the obstructing contamination from the spray nozzle or filter. The nozzle orifice and tip portion of the spray nozzle is cleaned by way of applying cleaning liquid into the flow channel with the help of a cleaning jet nozzle adapted movable into contact against the nozzle orifice and then out from the coating mix flow channel via a discharge opening adapted to the body of the spray nozzle. The filter located at the rear portion of the spray nozzle is cleaned by feeding cleaning liquid into the coating mix flow channel via the discharge opening of the spray nozzle body and then removing the cleaning liquid passed through the filter from a discharge opening adapted to the infeed pipe of the coating mix. After the obstruction is removed, the normal operation of the spray nozzle is restored.

More specifically, the method according to the invention is characterized by what is stated in the characterizing part of claim 1.

Furthermore, the apparatus according to the invention is characterized by what is stated in the characterizing part of claim 7.

The invention offers significant benefits.

A clogged spray nozzle or filter thereof can be cleaned rapidly without interrupting ongoing application. The function of a spray nozzle or array of nozzles to be cleaned can be replaced by a spray nozzle located in a different position along the spray nozzle row or by a different spray nozzle row, whereby no essential deterioration of the coating quality occurs. The cleaning liquid jet also removes coating mix deposits from the exterior surface of the spray nozzle orifice periphery.

In the following, the invention will be examined in greater detail by making reference to the appended drawings in which

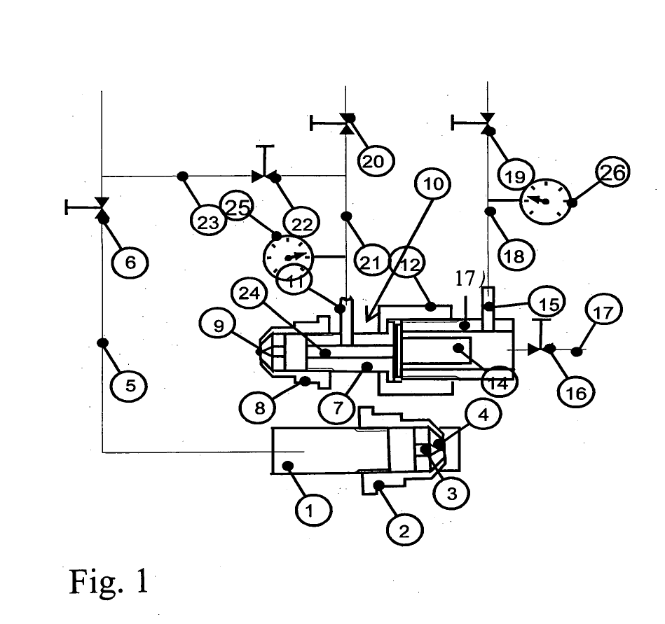

FIG. 1 shows schematically a spray nozzle of a spray coater and a cleaning jet nozzle, the latter being in its rest position.

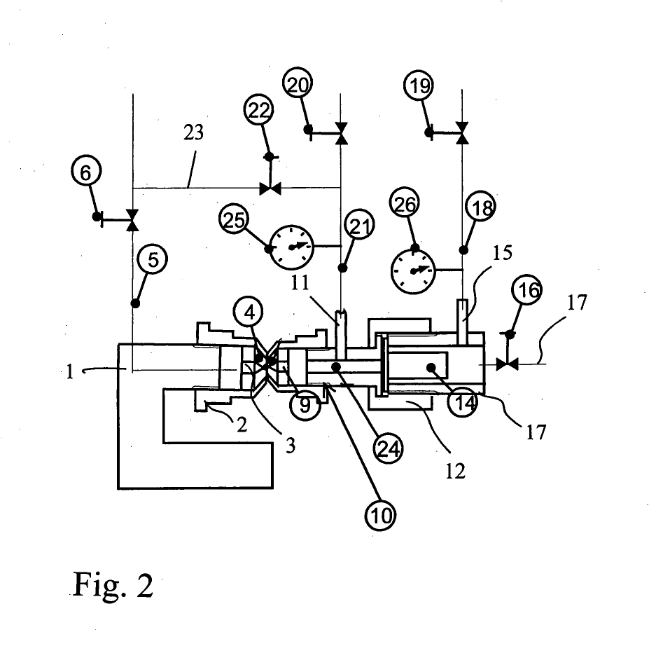

FIG. 2 shows schematically a spray nozzle of a spray coater and a cleaning jet nozzle, the latter being driven into its operating position.

A spray coater has a plurality of spray nozzles 10 mounted adjacent to each other in a linear array extending in the cross-machine direction over the width of the web. Generally, 3 to 20 spray nozzles 10 are required per a lineal meter of the cross-machine web width. As the quality of coating can be improved by using a greater number of linear nozzle arrays across the web, a spray coater may utilize several nozzle rows in succession. The nozzles of each linear array are mounted on a nozzle support beam, whose distance from the web being coated can be adjusted. Typically, the distance of the tip of nozzles 10 from the web being coated is in the order of 20-200 mm. The nozzles 10 are high-pressure nozzles generally delivering a coating mix spray at a pressure of 1 to 200 MPa. Typically, however, the nozzles are fed at a line pressure of 5 to 20 MPa.

Each spray nozzle 10 comprises a nozzle body 7 having a flow channel 24 formed therein. A nozzle piece 8 is mounted on the first end of the nozzle body 7. Into the nozzle piece 8 is formed a nozzle orifice 9, whose diameter in a high-pressure nozzle generally is in the order of 0.1-0.5 mm. The other end of the nozzle body 7 is provided with a filter 14. The nozzle body 7 and the filter 14 are connected to a coating mix feed pipe 17 with the help of a union nut 12. The feed pipe 17 is adapted closable and openable by means of a valve 16. The nozzle body 7 is equipped with a discharge opening 11 having thereto connected a pipe 21 adapted closable and openable by means of a valve 20. The infeed pressure of the coating mix in the flow channel 24 is monitored by means of a pressure gage 25 connected to the pipe 21 at a point between the discharge opening 11 and the valve 20. The coating mix feed pipe 17 has an opening 15 having connected thereto a pipe 18 adapted closable and openable by means of a valve 19. The pressure of coating mix flow in the feed pipe 17 is monitored by means of a pressure gage 26 connected to the pipe 18 at a point between the opening 15 and the valve 19.

A cleaning jet nozzle 4 used for cleaning a clogged spray nozzle 10 comprises a nozzle piece 2 connected to a cleaning jet nozzle body 1. The cleaning liquid is passed into the cleaning jet nozzle 4 via a feed pipe 5. The cleaning liquid feed pipe 5 is equipped with a valve 6 for controlling the liquid flow into the cleaning jet nozzle 4. Advantageously, the number of cleaning jet nozzles 4 is made equal to the number of spray nozzles 10 in each spray nozzle row placed in the cross-machine direction over the web width. The cleaning jet nozzles 4 of a given row are connected to a common support beam movable by actuator means. The mutual spacing of adjacent cleaning jet nozzles 4 is advantageously made equal to that of the adjacent spray nozzles 10, thus allowing the nozzles 10 of a given linear array to be cleaned simultaneously. The cleaning liquid feed pipe 5 adjoins the pipe 21 connected to the discharge opening 11 of the spray nozzle body 7 via a communicating pipe 23 having a valve 22 mounted thereon. In the flow direction of the cleaning liquid, the communicating pipe 23 is connected to the cleaning liquid feed pipe 5 at its one end at a point preceding the valve 6 and, at its other end, to the pipe 21 at a point between the valve 20 and the discharge opening 11.

During running, coating mix is fed via feed pipe 17 through filter 14 into flow channel 24 of spray nozzle body 7, whereupon the coating mix is atomized at nozzle orifice 9 of spray nozzle piece 8 into small droplets prior to its application to the web. When the coating is being applied in normal operation to the web surface, valve 16 of feed pipe 17 is controlled open, valves 20, 19 of discharge openings 11, 15 are controlled closed and valve 22 of communicating pipe 23 is controlled closed.

Flocked aggregate of coating mix or a lump passed through filter 14 may clog spray nozzle orifice 9. Also other particulate matter accumulated in filter 14 can cause clogging. The degree of clogging of spray nozzle 10 can be monitored during application with the help of pressure gauging means 25 adapted to discharge pipe 21 of the discharge opening 11. If the pressure sensed at this point rises substantially higher than its normal value, it indicates a blockage in flow channel 24 at a portion thereof between discharge opening 11 and nozzle orifice 9. Respectively, the degree of clogging of filter 14 can be monitored from the difference of pressure readings at points 25 and 26.

When pressure at measurement point 25 or the difference of pressure readings at measurement points 25 and 26 exceeds a predetermined threshold value, the cleaning cycle of nozzle 10 or filter 14 is initiated. The start of a cleaning cycle may be automated if so desired. At the start of a cleaning cycle for a spray nozzle 10 or a filter 14, the application of coating mix from spray nozzle 10 or a row of spray nozzles to be cleaned is cut off and the spray nozzle support beam is rotated about its longitudinal axis approx. 180° into the position shown in FIG. 1. Subsequently, the support beam of the cleaning jet nozzles with the cleaning jet nozzles 4 mounted thereon is moved from its rest position shown in FIG. 1 into the cleaning position shown in FIG. 2 with the help of, e.g., a hydraulic or pneumatic cylinder. For moving to a cleaning position, the nozzles 4 of the cleaning jet nozzle support beam are driven facing the nozzle orifices 9 of spray nozzles 10. If so desired, the cleaning jet nozzles 4 mounted on a common support beam can be adapted into a separate cleaning chamber that then is moved as an entity against the spray nozzles 10.

Cleaning liquid is ejected from a cleaning jet nozzle 4 into the flow channel 24 of a spray nozzle 10 in a reverse direction to normal flow of the coating mix. The normal flow direction of coating mix is from feed pipe 17 toward nozzle orifice 9. The cleaning liquid may be, e.g., water, chemicals or a mixture thereof. The ejection pressure of the cleaning liquid is typically 0.1 to 200 MPa, most advantageously 1 to 10 MPa. During the cleaning operation imposed on spray nozzle 10, valve 22 of communicating pipe 23 between cleaning liquid feed pipe 5 and discharge pipe 21 is kept closed, and also valve 19 of communicating tube 18 of discharge opening 15 is kept closed. Additionally, valve 16 of coating mix feed pipe 17 is kept closed, whereby no coating mix can reach spray nozzle 10. Valve 20 of discharge pipe 21 and valve 6 of cleaning liquid feed pipe 5 are kept open, whereby the cleaning liquid can flow from cleaning jet nozzle 4 into coating mix flow channel 24 via nozzle orifice 9 and further out from coating mix flow channel 24 via discharge opening 11 of spray nozzle body 7. Herein, any particle or aggregate of flocced coating mix clogging the coating mix flow channel between nozzle orifice 9 and discharge opening 11 is forced into discharge pipe 21 or, alternatively, the flow of cleaning liquid disintegrates the clogging aggregate. After the cause of clogging is removed, the spray nozzle support beam is rotated about its longitudinal axis approx. 180° so that nozzle orifices 9 of spray nozzles 10 again are oriented toward the web being coated. Furthermore, valves 16, 19, 20, 22 are driven back into their normal operating position, whereupon the application of the coating mix to the web surface can be started.

In a respective fashion during the cleaning cycle of filter 14, valve 6 of cleaning liquid feed pipe 5 and valve 20 of discharge pipe 21 are kept closed. Additionally, valve 16 of coating mix feed pipe 17 is kept closed, whereby no coating mix can reach spray nozzle 10. Valve 19 of discharge pipe 18 and valve 22 of communicating pipe 23 are kept open, whereby the cleaning liquid can flow from cleaning liquid feed pipe 5 via communicating pipe 23, discharge pipe 21 and discharge opening 11 into coating mix flow channel 24 and therefrom further through filter 14 in a reverse direction to the normal flow of the coating mix. Any particulate matter or aggregate of flocced coating mix accumulated in filter 14 is removed therefrom along with the reverse flow of cleaning liquid into discharge pipe 18 of discharge opening 15 or, alternatively, the flow of cleaning liquid disintegrates the clogging aggregate. Herein, it is not absolutely necessary to move the cleaning jet nozzle 4 to face nozzle orifice 9 of spray nozzle 10 during the cleaning cycle of filter 14. After the cause of clogging is removed, the spray nozzle support beam is rotated about its longitudinal axis approx. 180° so that nozzle orifices 9 of spray nozzles 10 again are oriented toward the web being coated. Furthermore, valves 16, 19, 20, 22 are driven back into their normal operating position, whereupon the application of the coating mix to the web surface can be started.

Also valve 19 of discharge pipe 18 may be kept open when spray nozzle 10 is being cleaned, whereby the cleaning liquid flows out via spray nozzle 10, as well as via discharge opening 11 and discharge opening 15. However, this may allow particles clogging nozzle orifice 9 to move into filter 14, whereby they are not removed from the system. Respectively, during the cleaning cycle of filter 14, cleaning liquid may be ejected into coating mix flow channel 24 from cleaning jet nozzle 4 via nozzle orifice 9 of spray nozzle 10 and then removed from flow channel 24 via discharge opening 15. Herein, valve 6 of cleaning liquid feed pipe 5 is kept open, while valve 20 of discharge pipe 21 of discharge opening 11, as well as valve 22 of communicating pipe 23, are kept closed. Also herein, particles clogging nozzle orifice 9 may move into filter 14, thus remaining in the system.

1. A method for cleaning a clogged or contaminated spray nozzle (10) or the filter (14) of such a spray nozzle used in coating a web of paper or paperboard, characterized in that into at least of portion of the coating mix flow channel (24) of the spray nozzle (10) to be cleaned is formed a cleaning medium flow running reverse to the normal flow direction of the coating mix.

2. The method according to claim 1, characterized in that the cleaning medium is passed into the coating mix flow channel (24) via the nozzle orifice (9) of the spray nozzle (10) and out from the coating mix flow channel (24) via a discharge opening (11) of the body (7) of the spray nozzle (10).

3. The method according to claim 1, characterized in that the cleaning medium is passed into the coating mix flow channel (24) via a discharge opening (11) of the body (7) of the spray nozzle (10) and out therefrom via a discharge opening (15) of the coating mix feed pipe (17).

4. The method according to claim 1, characterized in that the cleaning medium is passed into the coating mix flow channel (24) via the nozzle orifice (9) of the spray nozzle (10) and out from the coating mix flow channel (24) via a discharge opening (11) of the body (7) of the spray nozzle (10), as well as via a discharge opening (15) of the coating mix feed pipe (17).

5. The method according to claim 1, characterized in that water, chemicals or a mixture thereof is/are used as the cleaning medium.

6. The method according to claim 1, 2 or 4, characterized in that the cleaning medium is passed into the coating mix flow channel (24) by means of a cleaning jet nozzle (4) adapted movable against the nozzle orifice (9) of the spray nozzle (10).

7. An apparatus for cleaning a clogged or contaminated spray nozzle (10) or the filter (14) of such a spray nozzle used in coating a web of paper or paperboard, characterized by means suited for forming a cleaning medium flow running reverse to the normal flow direction of the coating mix into at least of portion of the coating mix flow channel (24) of the spray nozzle (10).

8. The apparatus according to claim 7, characterized in that said means comprise at least one cleaning jet nozzle (4) adapted movable against the nozzle orifice (9) of the spray nozzle (10).

9. The apparatus according to claim 8, characterized in that the cleaning jet nozzles (4) are mounted on a movable nozzle support beam.
